(19) United States
(12) Patent Application Publication
(10) Pub. No.: US 2010/0218382 A1
(43) Pub. Date: Sep. 2, 2010

(54) 5 in 1 Eating Utensil

(76) Inventor: Peter Henry Scott, Runaway Bay (AU)

Correspondence Address: Peter Henry Scott, 9 Koitaki Court, Runway Bay, 4216, AU

(21) Appl. No.: 12/396,095

(22) Filed: Mar. 2, 2009

(51) Int. Cl. A47J 43/28; B67B 7/44; B67B 7/16

(52) U.S. Cl. 30/147; 81/3.09; 81/3.55

(57) ABSTRACT

The enclosed is the 5 in 1 Eating Utensil that can be moulded from plastic in several different colours or can be pressed from steel or aluminium is comprised of 5 working parts being a provision of a fork (5) as part of the end of the spoon (7) and also part of that section of the underside of the spoon (7) a serrated knife (4) is attached as part of the mould, at the end of the shank a thumb a hole (6) of any particular shape to suit a person's thumb that is placed through the hole for those with disabilities in not being able to hold 10 onto the conventional knife, fork or spoon in the use of an eating utensils. At the end of the spoon there is an indentation (9) that can be used to open a pull ring can.

As part of the spoon as part of the mould on the underside is a shape of a screw top cap (10) that is used to undo twist top bottle caps

### FIELD OF THE INVENTION

The present invention relates to an eating utensil and more particularly to the design and manufacture of an eating utensil for a pacific use for certain consumers.

It can be moulded from plastic in any colour or pressed from steel or aluminium.

### BACKGROUND ART

Utensils for eating are commonly known with numerous designs and have been developed for specific dining and eating application, which have a significant impact on the dining experience for all types of consumers.

There exists a need for an eating utensil that can be used for consumers that cannot hold a knife fork or spoon without a great deal of difficulty, for those who suffer from arthritis, stroke victims, amputees and the aged.

### SUMMARY OF THE INVENTION

According to one embodiment of the present invention, the utensil having a knife section under the spoon allows a rocking action to cut an array of foods.

According to one embodiment of the present invention, the utensil having a Fork section at the end of the spoon allows the user to pick certain foods required by a fork use.

According to one embodiment of the present invention, the utensil having a Spoon section allows a consumer to take certain soups, ice cream, etc; According to one embodiment of the present invention, the utensil having a thumb hole in the handle end of the spoon for the user with holding problems to place their thumb through the hole to use the utensil effectively.

According to one embodiment of the present invention, the utensil having a wider handle for the user with holding problems is able to grip the handle.

According to one embodiment of the present invention, the utensil having at the end of the handle has an indentation for lifting flip top cans and in the middle underside of the shank a twist top bottle opener.

### BRIEF DESCRIPTION OF THE DRAWING

Various embodiment of the invention will be described with reference to following drawings, in which:

FIG. 1 is a schematic bottom view of the utensil of the present invention.

FIG. 2 is a schematic top view of the utensil of the present invention.

### DETAILED DESCRIPTION OF THE PREFERRED EMBODIMENT

According to the embodiment illustrated in the Figures, the 5 in 1 eating utensil consist of 5 being the fork moulded with the end of the spoon 7 that can be moulded in several different shapes and depths, under the spoon 7 a serrated knife 4 that can be moulded in several different shapes, depths and different sizes.

Part of the total mould the shank 8 has provision for a thumbhole 6 having several different dimensions. At the end of 8 an indentation for a flip top can opener 9. The underside of 8 a moulded form 10 for the use in removing twist top bottle top lids.

The claims defining the invention as follows:

1. The 5 in 1 eating utensil comprising of a knife, fork, spoon, thumbhole Screw top bottle opener and a flip top can opener.

2. The 5 in 1 eating utensil as claimed in claim (1) having a knife as part of The mould under the spoon and a fork attached to the spoon as part of the Mould.

3. The 5 in 1 eating utensil according as claimed in claims 1 and 2 can be Moulded from plastic or pressed from steel or aluminium.

4. The 5 in 1 eating utensil accordingly to any one of the claims 1-3 Where in the shank has provision for a thumbhole, a screw top bottle opener and a flip top can opener.

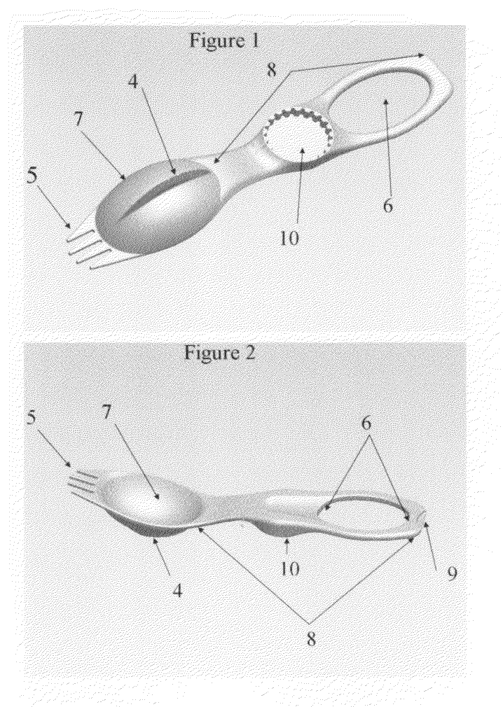

5. The 5 in 1 eating utensil can substantially as herein before described with Reference to FIGS. 1-2 of the accompanying drawings.
